(19) United States
(12) Patent Application Publication
(10) Pub. No.: US 2026/0159665 A1
(43) Pub. Date: Jun. 11, 2026

(54) SOLID COMPOSITE

(71) Applicant: SOUNDZIP LIMITED, Hong Kong (CN)

(72) Inventor: Kong Sang LEUNG, Hong Kong (CN)

(21) Appl. No.: 19/181,851

(22) Filed: Apr. 17, 2025

Related U.S. Application Data
(60) Provisional application No. 63/641,694, filed on May 2, 2024.

(30) Foreign Application Priority Data
Jul. 12, 2024 (HK) 32024094049.6

(51) Int. Cl. C08K 3/20; C08K 3/22

(52) U.S. Cl. CPC C08K 3/20; C08K 2003/2237

(57) ABSTRACT

The present invention relates to a solid composite, comprising: a first polymer, preferably solid having a porous structure; a second polymer, preferably different from said first polymer; a first additive, preferably selected from perovskite; and optionally a second additive; wherein said solid composite is prepared by first mixing the monomers for said first polymer with said second polymer, said first additive, and optionally said second additive, then solidifying said monomers to form said first polymer by means of polymerization, whereby said second polymer, said first additive, and optionally said second additive are dispersed in the porous structure of said first polymer.

### FIELD OF THE INVENTION

The present invention is related to a solid composite, and a method for preparing the polymeric composite. In particular, the solid composite is a polymeric solid composite.

### BACKGROUND

The majority of commercially available polymeric composites in the market contain harmful substances and non-renewable polymers, resulting in considerable waste generation. These conventional composite formulations heavily depend on virgin polymers, contributing significantly to the global polymer pollution problem. Furthermore, the manufacturing process involves the use of various toxic chemicals and solvents, further compromising the feasibility of production. Moreover, these unsustainable manufacturing practices generate long-term toxic waste and lack biodegradability.

Hence, the present innovation explores a novel polymeric composite that comprises recycled polymers, creating sustainable alternatives for commercial applications, promoting environmental sustainability. The polymeric composite developed in this invention can be configured to include functional additives or filler that can deliver different functions, such that the polymeric composite can be used in broad applications, including automotive, building construction, and sound insulation. Alternatively, this invention offers an alternative solution for public use.

### SUMMARY OF THE INVENTION

This first aspect of the present invention is related to a solid composite, comprising:
a first polymer, preferably solid having a porous structure;
a second polymer, preferably different from said first polymer;
a first additive, preferably selected from perovskite; and
optionally a second additive;
   wherein said solid composite is prepared by first mixing the monomers for said first polymer with said second polymer, said first additive, and optionally said second additive, then solidifying said monomers to form said first polymer by means of polymerization, whereby said second polymer, said first additive, and optionally said second additive are dispersed in the porous structure of said first polymer.

In some embodiments, said first polymer is selected from polyethylene-vinyl acetate, low-density polyethylene foam, nitrile rubber foam, polychloroprene foam, polyimide foam, polypropylene foam, polystyrene foam, polyurethane foam, polyurea foam, polyethylene foam, polyvinyl chloride foam, polyisocyanurate foam, silicone foam, microcellular foam, polyols, polyesters, polyacrylates, polyurethanes, poly thiols or a combination thereof. Preferably, the concentration of said first polymer varies from 1% w/w to 25% w/w in said solid composite.

In some embodiments, said second polymer is selected from polystyrene, polyurethane, polyethylene terephthalate, polyols, polyesters, polyacrylates, polyurethanes, poly thiols, polyethylene-vinyl acetate, low-density polyethylene foam, nitrile rubber foam, polychloroprene foam, polyimide foam, polypropylene foam, polystyrene foam, polyurethane foam, polyurea foam, polyethylene foam, polyvinyl chloride foam, polyisocyanurate foam, silicone foam, microcellular foam or a combination thereof. Preferably, the concentration of said second polymer varies from 30% w/w to 70% w/w in said solid composite. More preferably, said second polymer is recycled materials.

In some embodiments, said first additive is selected from lead perovskite crystal, lead-free perovskite crystal, lead-free double perovskite crystals, or a combination thereof. Advantageously, said first additive is characterized by high Goldschmidt's tolerance factor. More advantageously, the diameter of the crystal is in a range between 5 to 500 nm.

In some embodiments, lead-free perovskite crystal is selected from tin halide perovskite (CH₃NH₃)SnI₃, bismuth halide perovskite (CH₃NH₃)₃Bi₂I₉, antimony halide perovskite (CH₃NH₃)₃Sb₂I₉, silver bismuth iodide AgBiI₄, or a combination thereof.

In some embodiments, lead-free double perovskite crystal is selected from Cs₃Bi₂Br₉, Cs₂AgInCl₆, Cs₂AgBiBr₆, Cs₂AgBiI₆, Cs₂AgSbBr₆, Cs₂AgSbI₆, or a combination thereof.

In some embodiments, said first additive is Cs₂AgInBiCl₆, Cs₃Bi₂Cl₆, or a combination thereof.

In some embodiments, the concentration of said first additive varies from 0.01% w/w to 40% w/w, preferably from 0.01% w/w to 25% w/w, more preferably from 0.05% w/w to 40% w/w, most preferably from 0.05% w/w to 25% w/w in said solid composite.

In some embodiments, said second additive is selected from carbon nanotubes, carbon quantum dots, graphene, silica nanoparticles, metal nanoparticles including silver, gold, copper, or a combination thereof, clay nanoparticles including montmorillonite, halloysite, or a combination thereof, metal oxide nanoparticles including titanium dioxide, zinc oxide, aluminum oxide, or a combination thereof, cellulose nanofibers, or a combination thereof. Advantageously, said second additive is further selected from cellulose, chitosan, alginate, starch, dextran, or a combination thereof. More advantageously, said second additive is biodegradable. Preferably, said second additive has mean size in the range of 5 to 500 nm, preferably less than 10 nm. More preferably. the concentration of said second additive is from 0.02 wt % to 1 wt % in said solid composite.

In some embodiments, said solid composite further comprising:
blowing agents selected from water, carbon dioxide, hydrocarbons including propane, butane, pentane, or a combination thereof, hydrofluorocarbons (HFCs), hydrochlorofluorocarbons (HCFCs), azodicarbonamide (ADA), sodium bicarbonate, citric acid, sodium carbonate, ammonium bicarbonate, or a combination thereof; and/or
third additive comprising surfactant, stabilizer, plasticizer, crosslinking agent, or a combination thereof.

In some embodiments, the concentration of the blowing agent is from 1% w/w to 15% w/w in the composite.

In some embodiments, the concentration of said third additive is from 1% w/w to 30% w/w in the composite.

In some embodiments, the surfactant is selected from cetyltrimethylammonium bromide (CTAB), sodium dodecyl sulfate (SDS), oleic acid, dimethyldioctadecylammonium bromide (DDAB), polyethylene glycol and their corresponding block copolymers.

In some embodiments, the stabilizer is selected from oleic acid, oleylamine, Tween 20, cetyltrimethylammonium bromide (CTAB), or a combination thereof.

In some embodiments, the plasticizer is selected from glycerol ethyl acetate, sorbitol, ethylene glycol, xylitol, and diethylene glycol, or a combination thereof.

In some embodiments, the crosslinking agent is selected from isocyanates comprising toluene diisocyanate, p-xylylenediamine, gelatin, collagen, agarose, agar, or a combination thereof.

### BRIEF DESCRIPTION OF THE DRAWINGS

Some embodiments of the present invention will now be explained, with reference to the accompanied drawings, in which:

FIG. 1 illustrates the foam prepared by the first polymer of the present invention in different shapes and sizes;

FIGS. 2a and 2b are SEM images of Cs₂AgInBiCl₆;

FIGS. 3a and 3b are TEM images of Cs₃Bi₂Cl₆;

FIGS. 4a and 4b are SEM images of the cellulose nanoparticles and integrated with the composite prepared according to the present invention;

FIGS. 5a and 5b are TEM images of alginate nanoparticles;

FIGS. 6a and 6b are TEM images of chitosan nanoparticles;

FIGS. 7a and 7b are TEM images of dextran nanoparticles;

FIG. 8a is SEM image of the foam with different additives dispersed therein;

FIG. 8b is SEM image showing pore distribution of the foam;

FIGS. 9a and 9b illustrate the contact angles of the foam with hydrophobic features;

FIG. 10 shows the result of an acoustic testing ASTM E 2611-17 at 26° C. and 65% humidity; and

FIGS. 11a and 11b are SEM images showing different additives dispersed inside the composite.

### DETAILED DESCRIPTION OF PREFERRED EMBODIMENTS OF THE INVENTION

The present invention is now presented by way of examples with reference to the figures in the following paragraphs. Objects, features, and aspects of the present disclosure are disclosed in or are apparent from the following description. It shall be understood by one of ordinary skilled in the art that the following description is a description of exemplary embodiments only, and is not intended as limiting the broader aspects of the present disclosure, which broader aspects are embodied in the exemplary constructions.

It should be noted that, unless otherwise defined, the technical terms or scientific terms used in the embodiments of the present invention shall have the usual meanings understood by person with ordinary skills in the art to which the present invention belongs. “First”, “second” and similar expression used in the embodiments of the present invention do not indicate any order, quantity or importance, but are only used to distinguish different components.

Unless otherwise specified, all chemicals described herein are commercially available and used as received without special handling, and may include impurities, such as residual solvents or by-products. Unless otherwise stated, percentages herein refer to weight percentages. To facilitate the explanation of the present invention, the chemicals used in the description are examples only. It shall be understood that it does not have any limiting effect to the present invention.

The first aspect of the present invention will be first described, as below, i.e. a composite, which comprises:
a first polymer, preferably prepared in-situ;
a second polymer;
a first additive (interchangeably as first filler), preferably selected from perovskite crystal; and
a second additive (interchangeably as second filler).

Preferably, the composite is solid. More preferably, the first polymer is solid and has a porous structure.

With respect to the first polymer applicable in the present invention, it is preferable to use hydrophilic polymer, hydrophobic polymer, or a combination of these polymers. Long chain polymers and crosslinked polymers are also preferable.

It is mostly preferrable to use polymeric foam. Example of the first polymer can selected from polyethylene-vinyl acetate, low-density polyethylene foam, nitrile rubber foam, polychloroprene foam, polyimide foam, polypropylene foam, polystyrene foam, polyurethane foam, polyurea foam, polyethylene foam, polyvinyl chloride foam, polyisocyanurate foam, silicone foam, microcellular foam, or a combination thereof.

In some embodiments, polyols, polyesters, polyacrylates, polyurethanes, and poly thiols are also applicable for the first polymer.

Advantageously, the range of the concentration of the first polymer varies from 1% w/w to 25% w/w in the composite.

For illustration only, context below show how the polyurethane is prepared. However, those skilled in the art shall not interpret context below as the limitation to the present invention, in particular as the limitation to the first polymer applicable in the present invention.

In some embodiments, the polyurethane is prepared by polymeric methylene diphenyl diisocyanate (PMI). It is a type of diisocyanate compound commonly used in the production of polyurethane foams and resins. PMI is known for its high reactivity and is often used in the manufacturing of rigid polyurethane foams for insulation purposes.

In some embodiments, the polyurethane is prepared by methylene diphenyl diisocyanate (MDI). MDI is another type of diisocyanate compound used in the production of polyurethane polymers. MDI is primarily utilized in the manufacture of flexible polyurethane foams, such as those found in furniture, mattresses, and automotive seating.

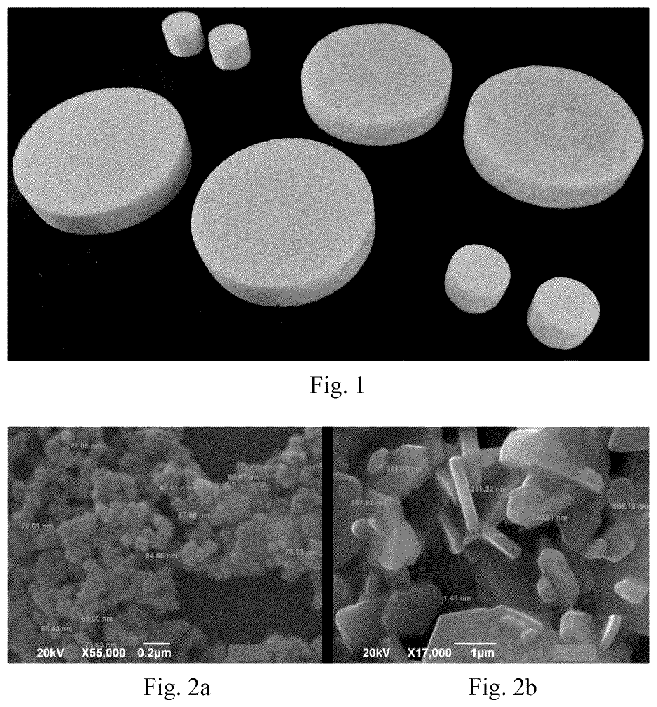

FIG. 1 illustrates the foam prepared by the first polymer of the present invention in different shapes and sizes.

With respect to the second polymer applicable in the present invention, hydrophilic as well as hydrophobic polymers are preferable. Long chain polymers and crosslinked polymers are also preferable.

The range of the concentration of the second polymer is preferably from 30% w/w to 75% w/w in the composite. Advantageously, the range of the concentration of the second polymer is from 50% w/w to 70% w/w in the composite. More advantageously, the concentration of the second polymer is at least 30% w/w in the composite.

Advantageously, the second polymer can be recycled polymers which are obtained from post-consumer

waste such as plastic bottles, containers, packaging materials, or a combination thereof. For example, the second polymer can be recycled polystyrene, polyurethane, polyethylene terephthalate, polyols, polyesters, polyacrylates, polyurethanes, poly thiols, or a combination thereof.

More advantageously, the second polymer can be recycled polymers selected from the following: polyethylene-vinyl acetate, low-density polyethylene foam, nitrile rubber foam, polychloroprene foam, polyimide foam, polypropylene foam, polystyrene foam, polyurethane foam, polyurea foam, polyethylene foam, polyvinyl chloride foam, polyisocyanurate foam, silicone foam, microcellular foam, or a combination thereof.

The formulation for preparing the composite of the present invention is economically viable, as it utilizes recycled polymers and reduces the need for virgin materials. Reusing waste polymer helps in the fight against climate change, global warming, and pollution worldwide, as it reduces the amount of waste sent to landfills and the need for new materials.

Experimental study indicates that the concentration of the second polymer exerts influence on the foam density and the pore size of the composite of the present invention. Experimental study indicates that the lower the concentration of the second polymer, the better the foam density and the better the pore size distribution.

With respect to the first additive applicable in the present invention, the range of concentration of the first additive is preferably from 0.01% w/w to 40% w/w, preferably from 0.01% w/w to 25% w/w, more preferably from 0.05% w/w to 40% w/w, most preferably from 0.05% w/w to 25% w/w. It shall be understood that any number in these numeral ranges can be an end point for another numeral range. It can be of different shapes such as spherical, cubic, and hexagonal, preferably with lattice structure having higher number of defects. In some embodiments, perovskite crystal in particular perovskite nanocrystal is preferable. Nanocrystals with Goldschmidt's tolerance factor ranging from 0.8 to 1 is preferable. In some embodiments, the perovskite crystal that supports fluorescence via radiative or non-radiative pathways is preferable. The diameter of the crystal size is preferably in a range between 5 to 500 nm. The example of perovskite crystal is selected from lead perovskite crystal, lead-free perovskite crystal, lead-free double perovskite crystals, or a combination thereof.

Lead-free perovskite crystal is selected from tin halide perovskite (CH₃NH₃)SnI₃, bismuth halide perovskite (CH₃NH₃)₃Bi₂I₉, antimony halide perovskite (CH₃NH₃)₃Sb₂I₉, silver bismuth iodide AgBiI₄, or a combination thereof.

Lead-free double perovskite crystal is selected from Cs₃Bi₂Br₉, Cs₂AgInCl₆, Cs₂AgBiBr₆, Cs₂AgBiI₆, Cs₂AgSbBr₆, Cs₂AgSbI₆, or a combination thereof.

In some embodiments, Cs₂AgInBiCl₆ can be used, which is the type of lead-free double perovskite nanocrystal. SEM images of Cs₂AgInBiCl₆ are shown in FIGS. 2a and 2b.

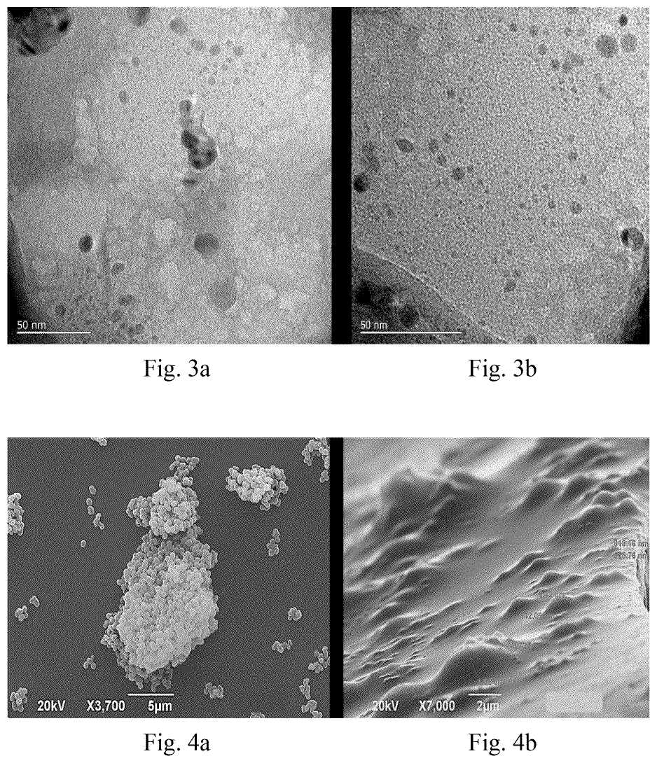

In some embodiments, Cs₃Bi₂Cl₆ can be used, which is the type of lead-free perovskite nanocrystal. The nanocrystals of Cs₃Bi₂Cl₆ at size less than 20 nm as seen from FIGS. 3a and 3b.

Preferably, the crystals and/or nanocrystals are synthesized at room temperature, which reduces energy consumption and cost, and have high atom economy and provide a sustainable alternative to the existing fillers used in the industry. “High atom economy” in context refers to a measure of the efficiency of a chemical reaction in utilizing starting materials, in the preparation of perovskite materials. “High atom economy” indicates the high yield of the product, indicating a significant conversion of the starting precursor into the desired perovskite product, with a yield of up to 70% of the initial precursor concentration. Furthermore, their high atom economy ensures efficient utilization of raw materials, resulting in a sustainable alternative to conventional nanofillers used in the industry.

The crystal in particular the nanocrystals are synthesized at room temperature and have high atom economy and provide a sustainable alternative to the existing nanofillers used in the industry.

### Preparation of Lead-Free Perovskite Nanocrystals at Room Temperature at Ambient Conditions

Dissolve the desired precursors (e.g., cesium chloride, bismuth chloride, and methylammonium chloride) in a suitable solvent (e.g., dimethylformamide or dimethyl sulfoxide) at a concentration of 0.1-1M. Mix the precursor solution with a coordinating solvent

(e.g., Oleic acid) and a surfactant (e.g., Oleyl amine or Oleic acid) in a 3:1:1 molar ratio. The mixture was vigorously stirred at 500-1000 rpm for 2-3 hours. Cool the reaction mixture to room temperature and add a nonpolar solvent (e.g., hexane) to precipitate the perovskite nanocrystals. Centrifuge the resulting suspension at 10,000-15,000 rpm for 15-20 minutes to collect the nanocrystals. Wash the collected nanocrystals with a nonpolar solvent several times to remove any residual solvent or impurities. Dry the nanocrystals at room temperature or under vacuum to obtain a dry powder. The nanocrystals of Cs₃Bi₂Cl₆ at size less than 20 nm as seen from FIGS. 3a and 3b.

With respect to the second additive applicable in the present invention, it can be of carbon nanotubes, carbon quantum dots, graphene, silica nanoparticles, metal nanoparticles including silver, gold, copper, or a combination thereof, clay nanoparticles including montmorillonite, halloysite, or a combination thereof, metal oxide nanoparticles including titanium dioxide, zinc oxide, aluminum oxide, or a combination thereof, cellulose nanofibers, or a combination thereof.

It can also be of biodegradable materials that include cellulose, chitosan, alginate, starch, dextran, or a combination thereof. The biodegradable material is selected based on its high surface area, compatibility with the polymer, biodegradability, and a combination thereof. The particles synthesized by biodegradable materials may advantageously have the mean size in the range of 5 to 500 nm. The concentration of these nanoparticles maybe from 0.02 wt % to 1 wt % in the composite.

In some embodiments, biomolecules with large groups such as the ones present in alginate structure (G and M blocks) are also preferable.

In some embodiments. the range of concentration of the second additive is preferably from 0.01 M to 4 M.

In some embodiments, the second additive includes quantum dots of less than 10 nm size as nanofillers to optimize performance.

The use of biodegradable fillers further contributes to the sustainability, as it reduces the environmental impact of the composite formulation.

### Preparation of Cellulose Nanoparticles From Cellulose Acetate

Dissolve cellulose acetate in an acetone/water mixture (9:1) at a concentration of 2-5% (w/w). Homogenize the solution using a high-speed homogenizer for 10-15 minutes. Add the homogenized solution to a large volume of deionized water while stirring continuously. Centrifuge the resulting suspension at 10,000-15,000 rpm for 15-20 minutes to collect the cellulose nanoparticles. Wash the collected nanoparticles with deionized water several times to remove any residual solvent or impurities. Dry the nanoparticles at room temperature or under vacuum to obtain a dry powder. The SEM images of cellulose nanoparticles are shown in FIGS. 4a and 4b.

### Preparation of Alginate Nanoparticles From Sodium Alginate

Dissolve sodium alginate in deionized water at a concentration of 0.5-2% (w/w). Add the desired amount of crosslinking agent (e.g., calcium chloride) to the alginate solution under constant stirring. Homogenize the mixture using a high-speed homogenizer for 10-15 minutes. Dropwise add the homogenized mixture to a large volume of deionized water while stirring continuously. Centrifuge the resulting suspension at 10,000-15,000 rpm for 15-20 minutes to collect the alginate nanoparticles. Wash the collected nanoparticles with deionized water several times to remove any residual crosslinking agent or impurities. Dry the nanoparticles at room temperature or under vacuum to obtain a dry powder. The TEM images of alginate nanoparticles are shown in FIGS. 5a and 5b.

### Preparation of Chitosan Nanoparticles at Room Temperature at Ambient Conditions

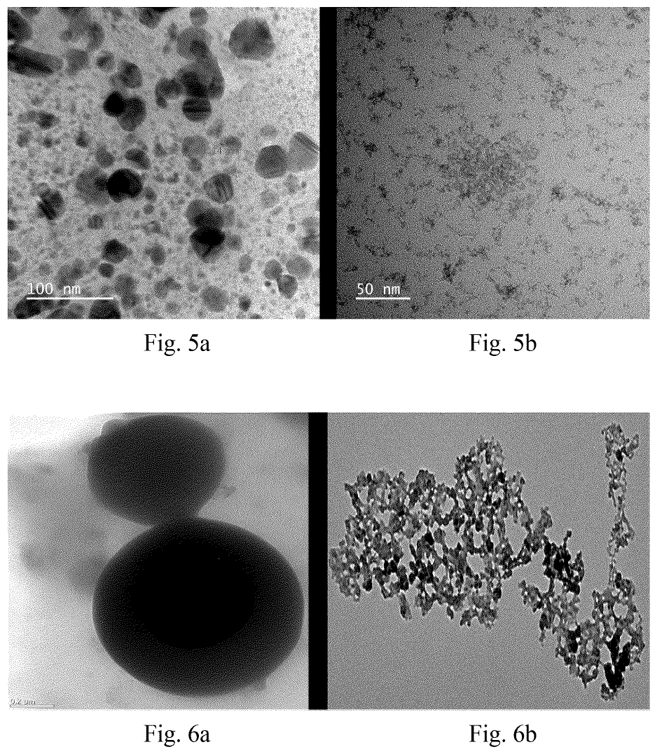

Dissolve chitosan in acetic acid or another suitable solvent at a concentration of 0.5-2% (w/w). Add the desired amount of crosslinking agent (sodium tripolyphosphate) to the chitosan solution under constant stirring. Homogenize the mixture using a high-speed homogenizer for 10-15 minutes. Dropwise add the homogenized mixture to a large volume of deionized water while stirring continuously. Centrifuge the resulting suspension at 10,000-15,000 rpm for 15-20 minutes to collect the chitosan nanoparticles. Wash the collected nanoparticles with deionized water several times to remove any residual crosslinking agent or impurities. Dry the nanoparticles at room temperature or under vacuum to obtain a dry powder. The TEM images of chitosan nanoparticles are shown in FIGS. 6a and 6b.

### Preparation of Dextran Nanoparticles at Room Temperature at Ambient Conditions

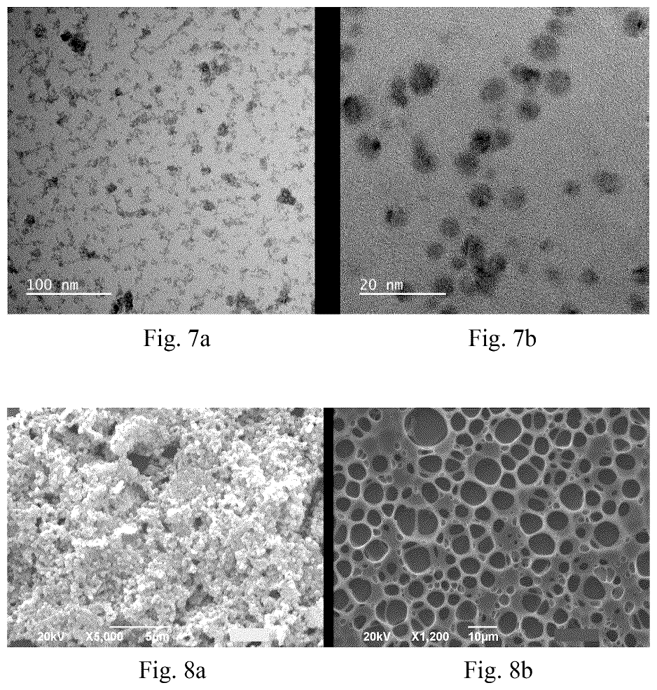

Dissolve dextran in deionized water at a concentration of 0.5-2% (w/w). Add the desired amount of crosslinking agent (glutaraldehyde) to the dextran solution under constant stirring. Homogenize the mixture using a high-speed homogenizer for 10-15 minutes. Dropwise add the homogenized mixture to a large volume of deionized water while stirring continuously. Centrifuge the resulting suspension at 10,000-15,000 rpm for 15-20 minutes to collect the dextran nanoparticles. Wash the collected nanoparticles with deionized water several times to remove any residual crosslinking agent or impurities. Dry the nanoparticles at room temperature or under vacuum to obtain a dry powder. The TEM images of dextran nanoparticles are shown in FIGS. 7a and 7b.

In some embodiments, the composite of the present invention comprises:
a first polymer, preferably prepared in-situ;
a second polymer;
a first additive (interchangeably as first filler), preferably selected from perovskite crystal;
a second additive (interchangeably as second filler); and
blowing agents.

With respect to the blowing agents, it can be of water, carbon dioxide, hydrocarbons including propane, butane, pentane, or a combination thereof, hydrofluorocarbons (HFCs), hydrochlorofluorocarbons (HCFCs), azodicarbonamide (ADA), sodium bicarbonate, citric acid, sodium carbonate, ammonium bicarbonate, or a combination thereof. Advantageously, water, carbon dioxide, or a combination thereof is/are used. The range of concentration is preferably from 1% w/w to 15% w/w in the composite.

In some embodiments, composite of the present invention comprises:
a first polymer, preferably prepared in-situ;
a second polymer;
a first additive (interchangeably as first filler), preferably selected from perovskite crystal;
a second additive (interchangeably as second filler);
blowing agents; and
third additive (interchangeably as third filler).

With respect to the third additive, it can be of surfactants, stabilizers, plasticizers, crosslinking agents, or a combination thereof. The third additives optimize the composite formation process, improve material properties, and ensure stability and durability. Specific examples of the third additive can be of toluene, isopropyl alcohol, hexane, chloroform, ethanol;
stabilizers including oleic acid, oleylamine, Tween 20, cetyltrimethylammonium bromide (CTAB), or a combination thereof;
surfactants including cetyltrimethylammonium bromide (CTAB), sodium dodecyl sulfate (SDS), oleic acid, dimethyldioctadecylammonium bromide (DDAB), polyethylene glycol, their corresponding block copolymers, or a combination thereof;
plasticizers including glycerol, ethyl acetate, sorbitol, ethylene glycol, xylitol, and diethylene glycol, or a combination thereof;
crosslinking agents including isocyanates such as toluene diisocyanate, p-xylylenediamine,

gelatin, collagen, agarose, agar, or a combination thereof. The range of concentration is preferably from 1% w/w to 30% w/w in the composite.

In particular, the surfactant may consist of at least one chemical from the following group cetyltrimethylammonium bromide (CTAB), sodium dodecyl sulfate (SDS), oleic acid, dimethyldioctadecylammonium bromide (DDAB), polyethylene glycol and their corresponding block copolymers.

FIG. 8a is SEM image of the foam with different additives dispersed therein.

FIG. 8b is SEM image showing pore distribution of the foam.

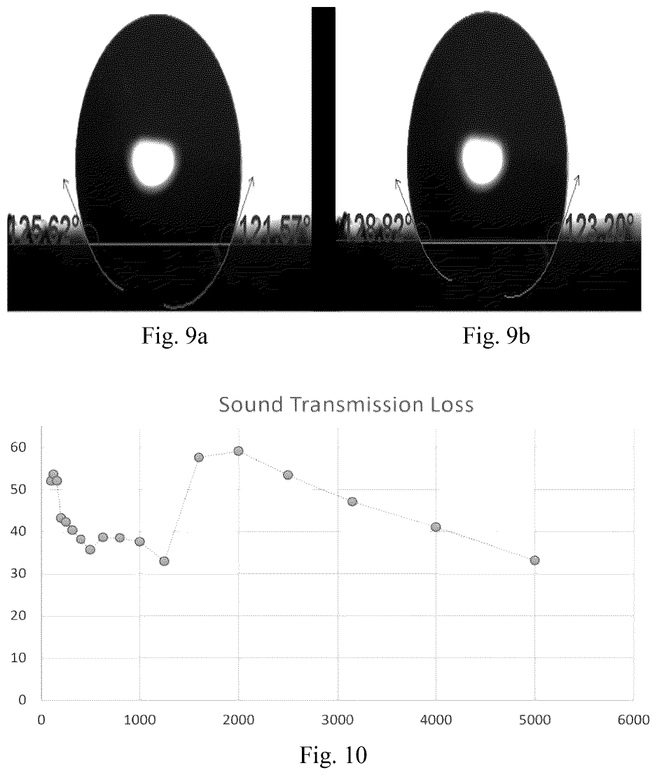

FIGS. 9a and 9b illustrate the contact angles of the foam with hydrophobic features. These figures show that the contact angles of the final foams are more than 120°, demonstrating that these foams are highly hydrophobic in nature.

The composite of the present invention can be used in a wide range of commercial applications, including automotive, building construction, and sound insulation.

In automotive applications, the composite can be used to improve the acoustic comfort of vehicles and reduce the transmission of engine noise.

In building construction applications, the composite can be used to improve the acoustic performance of walls, ceilings, and floors. The composite of the present invention can be employed as a building material with applications as but not limited to panel for facade, partitioning wall, thermal insulating layer, sound proofing wall in the buildings and doors.

In sound insulation applications, the composite can be used to reduce noise pollution in buildings, vehicles, and industrial facilities. The composite of the present invention exhibits excellent acoustic absorption properties due to its high surface area and porous structure. The embedded fillers in particular nanofillers also enhance the acoustic properties of the composite by increasing the sound scattering and damping effects.

The composite of the present invention can be configured to advantageously utilize recycled plastic into functional acoustic panels with better acoustic properties due to the presence of additives such as biodegradable additives. The present invention gives a sustainable avenue to transform the sustainability feature of the building complexes and protects the users from the harmful effects of noise pollution. For high density population places like Hong Kong, such solutions can help create tremendous positive social impact and alleviate the health concerns.

The Sound Transmission Class (STC) values were measured using an ASTM E 2611-17 acoustic testing setup with the frequency range between 100 to 5000 Hz with the highest transmission loss up to 59.1 dB.

FIG. 10 shows the result of an acoustic testing ASTM E 2611-17 at 26° C. and 65% humidity, in which the x-axis is frequency (Hz) and the y-axis is sound transmission loss (dB). The test was performed using the guidelines of ASTM E 2611-17. FIG. 10 shows the STL loss is at max when the frequency is about 2000 Hz.

The resulting acoustic panels have high STC values, making them effective in reducing noise levels in residential buildings, offices, and large construction projects. The panels are easy to integrate into existing structures and can be customized to fit any size or shape. The preferable use of recycled plastic as the base material reduces the overall precursor cost, making the panels more affordable and accessible to a wider audience.

As the surface area of the composite is enhanced due to the presence of the additives, the fundamental interactions, interactions of sound waves at the molecular level with different polymers and additives present therein, at the molecular levels increase 100-fold and allow maximum conversion of applied sound waves. The presence of a high concentration of additives, preferable nanoparticles, within a composite has several significant effects on sound transmission. Firstly, each nanoparticle serves as an active site due to its nanoscale size, resulting in a rapid increase in the number of active surface areas. This heightened surface area enables a greater interaction between the nanoparticles and the applied sound wave, leading to the conversion of sound energy into other forms. Moreover, the nanoparticles facilitate the scattering of sound waves in all directions. As the sound wave encounters these nanoparticles, it undergoes scattering, causing a reduction in its overall energy. This scattering phenomenon occurs in various directions, further contributing to the diminished energy of the incoming sound wave. Consequently, these interactions between the nanoparticles and the sound wave result in the rapid dissipation of the overall energy of the applied sound wave. The conversion of sound energy into other forms, combined with the scattering of sound waves, accelerates the dissipation process. This ultimately leads to improved sound transmission loss, as the energy of the sound wave is efficiently dissipated and attenuated within the system. In addition, due to the foamy feature of polymer such as polyurethane, the residual sound waves and energies are easily dissipated across the polymer matrix. Therefore, the disclosed composite of the present invention actively contributes in sound dampening, absorption, conversion, and dissipation, hence the overall efficiency of this panel is better than the existing technologies in the same domain.

In the composite of the present invention, the first additives have robust energy absorption capabilities without degrading their crystal lattice, phase, and morphologies.

The first and second additives enhance the STC values of the polyurethane foam and the structural properties of the composite, thereby extending their overall lifespan. The nanofillers are derived from sustainable sources and are non-toxic, making them an environmentally friendly solution.

Density of the composite is in the range of 50-200 kg/m³. The composite enforces the sound waves to dissipate into different forms of energy like heat and the embedded additives, allowing it to be scattered in all the direction to reduce the energy of the incoming wave. The nanofillers can capture the energy of the sound waves without degrading their lattice structure and functional properties.

Furthermore, the present invention offers a solution to the pressing issue of waste management. By utilizing recycled polymer such as polystyrene and polyethylene terephthalate as the primary materials, this approach effectively minimizes waste generation and aids in pollution reduction. The fillers in particular the nanofillers used in the present invention are preferably derived from sustainable sources and are biodegradable, making them environmentally friendly. The present invention presents a sustainable solution that not only addresses noise pollution but also contributes to the overall well-being of the environment. Consequently, the resulting products are more eco-friendly while possessing robust acoustic properties, making them a green and sustainable alternative within the construction sector.

The present invention introduces an environmentally sustainable and cost-effective method for manufacturing acoustic panels with excellent STC values. By employing recycled polymer as the base materials and incorporating fillers, preferably nanofillers, more preferably biodegradable fillers and/or nanofillers, the STC values of the composite is enhanced, along with the structural properties of the panels, thereby extending their overall lifespan. This invention not only tackles the growing issue of waste management but also promotes the environmental well-being.

For example, contents below provide a method for preparing a composite comprising polyurethane foam as the first polymer; recycled polystyrene and recycled polyethylene terephthalate as the second polymer; Cs₂AgInBiCl₆ as the first additive; dextran as the second additive; isothiocyanate solution as the cross-linking agent. The mixing steps in the example can be performed in a high-shear mixer. One shall understand that this example is for illustration only and shall not be construed as any limitation to the present invention.

The method comprises the following process:

### Step 1: Preparation of the Recycled Materials

This processing step involves reducing the recycled materials into smaller particles. Recycled polystyrene and polyethylene terephthalate are processed to achieve the desired particle size and shape.

### Step 2: Mixing the Recycled Materials With Polyurethane Foam Precursor

The processed particles of recycled polystyrene and polyethylene terephthalate are mixed with a polyurethane foam precursor. The foam precursor typically consists of a polyol solution and isothiocyanate.

### Step 3: Addition of the First and the Second Additives

The first and the second additives are separately added to the mixture prepared in step 2. These additives have properties that enable them to convert sound energy into heat energy, which is dissipated throughout the pores present in the foam structure of the composite that will be prepared.

### Step 4: Vigorous Mixing

The mixture of polyol solution, melted recycled polymers, and nanofillers is vigorously mixed. A stirring speed of 600-1000 rpm is employed to ensure thorough blending and uniform distribution of all the components.

### Step 5: Addition of Isothiocyanate Solution

After complete and uniform mixing in step 4, an isothiocyanate solution is added to the mixture. This solution acts as a cross-linking agent for the polyurethane foam formation.

### Step 6: Formation of Polyurethane Foam

The mixture is continuously stirred after the addition of the isothiocyanate solution. Within 30 seconds, the polyurethane foam starts to form instantly due to the reaction between the polyol and isothiocyanate. The foam is allowed to cool at room temperature until it is completely dried.

The resulting polyurethane foam composite exhibits a foam structure with low density, high porosity, and high surface area.

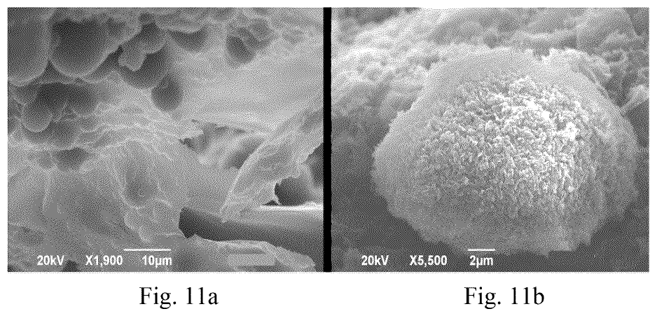

FIGS. 11a and 11b are SEM images of different additives dispersed inside the composite.

Although the specification does not exhaustively describe the processing parameters for all

possible materials suitable for the present invention, one shall understand that those commonly known processing parameters for all said possible materials are also within the disclosure of the present invention.

Experimental study indicates that the concentration of the second polymer exerts influence on the foam density and the pore size of the composite of the present invention. Experimental study indicates that the lower the concentration of the second polymer, the better the foam density and the better the pore size distribution, leading to the better acoustic absorption property. On the contrary, higher concentration of the second polymer leads to rigid foam structure thus disrupting the pore size. The first additive provides better structural and mechanical properties. The second additive provides better acoustic properties due to its flexibility at the molecular level.

The present invention provides a sustainable and high-performance foam formulation that addresses the need for environmentally friendly materials in various industries. The use of recycled polymers and biodegradable nanofillers reduces the environmental impact of the foam formulation, while also contributing to the fight against climate change, global warming, and pollution worldwide. The foam formulation is also cost-effective and can be used in a wide range of commercial applications, making it a promising innovation for the future.

The description of the above embodiments is only used to help understanding the method and core idea of the present invention. For those of ordinary skill in the art, without departing from the principle of the present invention, several improvements and modifications can be made to the present invention, and these improvements and modifications also fall within the protection scope of the claims of the present invention. Various modifications to these embodiments are obvious to those skilled in the art, and the general principles defined herein can be implemented in other embodiments without departing from the spirit or scope of the present invention. Therefore, the present invention will not be limited to the embodiments shown in this document but should conform to the widest scope consistent with the principles and novel features disclosed in this document and their equivalents.

What is claimed is:

1. A solid composite, comprising:
a first polymer, preferably solid having a porous structure;
a second polymer, preferably different from said first polymer;
a first additive, preferably selected from perovskite; and
optionally a second additive;
wherein said solid composite is prepared by first mixing the monomers for said first polymer with said second polymer, said first additive, and optionally said second additive, then solidifying said monomers to form said first polymer by means of polymerization, whereby said second polymer, said first additive, and optionally said second additive are dispersed in the porous structure of said first polymer.

2. The solid composite as claimed in claim 1, wherein said first polymer is selected from polyethylene-vinyl acetate, low-density polyethylene foam, nitrile rubber foam, polychloroprene foam, polyimide foam, polypropylene foam, polystyrene foam, polyurethane foam, polyurea foam, polyethylene foam, polyvinyl chloride foam, polyisocyanurate foam, silicone foam, microcellular foam, polyols, polyesters, polyacrylates, polyurethanes, poly thiols or a combination thereof, preferably the concentration of said first polymer varies from 1% w/w to 25% w/w in said solid composite.

3. The solid composite as claimed in claim 1, wherein said second polymer is selected from polystyrene, polyurethane, polyethylene terephthalate, polyols, polyesters, polyacrylates, polyurethanes, poly thiols, polyethylene-vinyl acetate, low-density polyethylene foam, nitrile rubber foam, polychloroprene foam, polyimide foam, polypropylene foam, polystyrene foam, polyurethane foam, polyurea foam, polyethylene foam, polyvinyl chloride foam, polyisocyanurate foam, silicone foam, microcellular foam or a combination thereof, preferably the concentration of said second polymer varies from 30% w/w to 70% w/w in said solid composite

4. The solid composite as claimed in claim 3, wherein said second polymer is recycled materials.

5. The solid composite as claimed in claim 1, wherein said first additive is selected from lead perovskite crystal, lead-free perovskite crystal, lead-free double perovskite crystals, or a combination thereof, preferably the lead-free perovskite crystal is selected from tin halide perovskite (CH₃NH₃)SnI₃, bismuth halide perovskite (CH₃NH₃)₃Bi₂I₉, antimony halide perovskite (CH₃NH₃)₃Sb₂I₉, silver bismuth iodide AgBiI₄, or a combination thereof and preferably the lead-free double perovskite crystal is selected from Cs₃Bi₂Br₉, Cs₂AgInCl₆, Cs₂AgBiBr₆, Cs₂AgBiI₆, Cs₂AgSbBr₆, Cs₂AgSbI₆, or a combination thereof.

6. The solid composite as claimed in claim 5, wherein said first additive is characterized by high Goldschmidt's tolerance factor.

7. The solid composite as claimed in claim 5, wherein the diameter of the crystal is in a range between 5 to 500 nm.

8. The solid composite as claimed in claim 1, wherein said first additive is Cs₂AgInBiCl₆, Cs₃Bi₂Cl₆, or a combination thereof.

9. The solid composite as claimed in claim 1, wherein the concentration of said first additive varies from 0.01% w/w to 40% w/w, preferably from 0.01% w/w to 25% w/w, more preferably from 0.05% w/w to 40% w/w, most preferably from 0.05% w/w to 25% w/w in said solid composite.

10. The solid composite as claimed in claim 1, wherein said second additive is selected from carbon nanotubes, carbon quantum dots, graphene, silica nanoparticles, metal nanoparticles including silver, gold, copper, or a combination thereof, clay nanoparticles including montmorillonite, halloysite, or a combination thereof, metal oxide nanoparticles including titanium dioxide, zinc oxide, aluminum oxide, or a combination thereof, cellulose nanofibers, or a combination thereof.

11. The solid composite as claimed in claim 10, wherein said second additive is further selected from cellulose, chitosan, alginate, starch, dextran, or a combination thereof.

12. The solid composite as claimed in claim 11, wherein said second additive is biodegradable.

13. The solid composite as claimed in claim 1, wherein said second additive has mean size in the range of 5 to 500 nm, preferably less than 10 nm, preferably the concentration of said second additive is from 0.02 wt % to 1 wt % in said solid composite.

14. The solid composite as claimed in claim 1, wherein said solid composite further comprising:
blowing agents selected from water, carbon dioxide, hydrocarbons including propane, butane, pentane, or a combination thereof, hydrofluorocarbons (HFCs), hydrochlorofluorocarbons (HCFCs), azodicarbonamide (ADA), sodium bicarbonate, citric acid, sodium carbonate, ammonium bicarbonate, or a combination thereof; and/or
third additive comprising surfactant, stabilizer, plasticizer, crosslinking agent, or a combination thereof.

15. The solid composite as claimed in claim 14, wherein the concentration of the blowing agent is from 1% w/w to 15% w/w in said solid composite.

16. The solid composite as claimed in claim 15, wherein the concentration of said third additive is from 1% w/w to 30% w/w in said solid composite.

17. The solid composite as claimed in claim 16, wherein the surfactant is selected from cetyltrimethylammonium bromide (CTAB), sodium dodecyl sulfate (SDS), oleic acid, dimethyldioctadecylammonium bromide (DDAB), polyethylene glycol and their corresponding block copolymers.

18. The solid composite as claimed in claim 16, wherein the stabilizer is selected from oleic acid, oleylamine, Tween 20, cetyltrimethylammonium bromide (CTAB), or a combination thereof.

19. The solid composite as claimed in claim 16, wherein the plasticizer is selected from glycerol, ethyl acetate, sorbitol, ethylene glycol, xylitol, and diethylene glycol, or a combination thereof.

20. The solid composite as claimed in claim 16, wherein the crosslinking agent is selected from isocyanates comprising toluene diisocyanate, p-xylylenediamine, gelatin, collagen, agarose, agar, or a combination thereof.
